(19) United States
(12) Patent Application Publication
(10) Pub. No.: US 2020/0032950 A1
(43) Pub. Date: Jan. 30, 2020

(54) Collapsible Mobile Device Stand

(71) Applicant: Barnabas Abraham, Houston, TX (US)

(72) Inventor: Barnabas Abraham, Houston, TX (US)

(21) Appl. No.: 16/044,592

(22) Filed: Jul. 25, 2018

(51) Int. Cl. F16M 11/28; H04M 1/04; H04B 1/3877

(52) U.S. Cl. CPC F16M 11/28; F16M 11/041; H04B 1/3877; H04M 1/04

(57) ABSTRACT

A collapsible mobile device stand for portable mobile device support includes a telescopic pole having a top end, a bottom end, and a plurality of segments. Each of the plurality of segments is telescopably coupled within an adjacent segment of the plurality of segments. The telescopic pole has an extended position and an alternate compacted position. A plurality of hinges is coupled to the telescopic pole proximal the bottom end. A plurality of legs is coupled to the plurality of hinges, and each of the plurality of legs is independently foldable from a folded position to an alternate extended position. Each of a plurality of feet is coupled to a distal end of one of the plurality of legs. A device holder assembly is coupled to the top end of the telescopic pole and is configured to secure and alternatively release a mobile device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to tripods and more particularly pertains to a new tripod for portable mobile device support.

### BRIEF SUMMARY OF THE INVENTION

An embodiment of the disclosure meets the needs presented above by generally comprising a telescopic pole having a top end, a bottom end, and a plurality of segments. Each of the plurality of segments is telescopably coupled within an adjacent segment of the plurality of segments. The telescopic pole has an extended position and an alternate compacted position. A plurality of hinges is coupled to the telescopic pole proximal the bottom end. A plurality of legs is coupled to the plurality of hinges, and each of the plurality of legs is independently foldable from a folded position to an alternate extended position. Each of a plurality of feet is coupled to a distal end of one of the plurality of legs. A device holder assembly is coupled to the top end of the telescopic pole and is configured to secure and alternatively release a mobile device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a collapsible mobile device stand according to an embodiment of the disclosure.

FIG. 2 is a front elevation view of an embodiment of the disclosure.

FIG. 3 is a front elevation view of an embodiment of the disclosure in an alternate position.

FIG. 4 is a top plan in-use view of an embodiment of the disclosure.

FIG. 5 is a cross-sectional view of an embodiment of the disclosure along line 5-5 of FIG. 2.

### DETAILED DESCRIPTION OF THE INVENTION

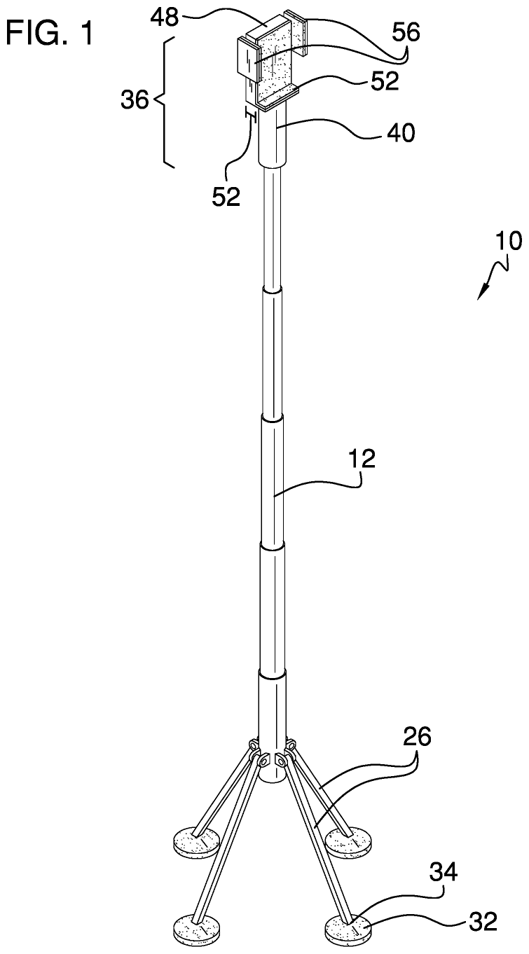

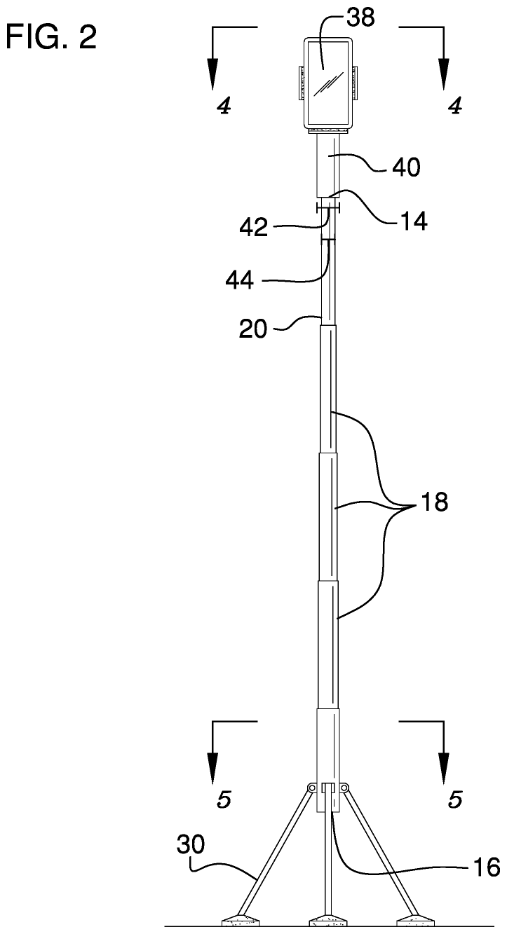

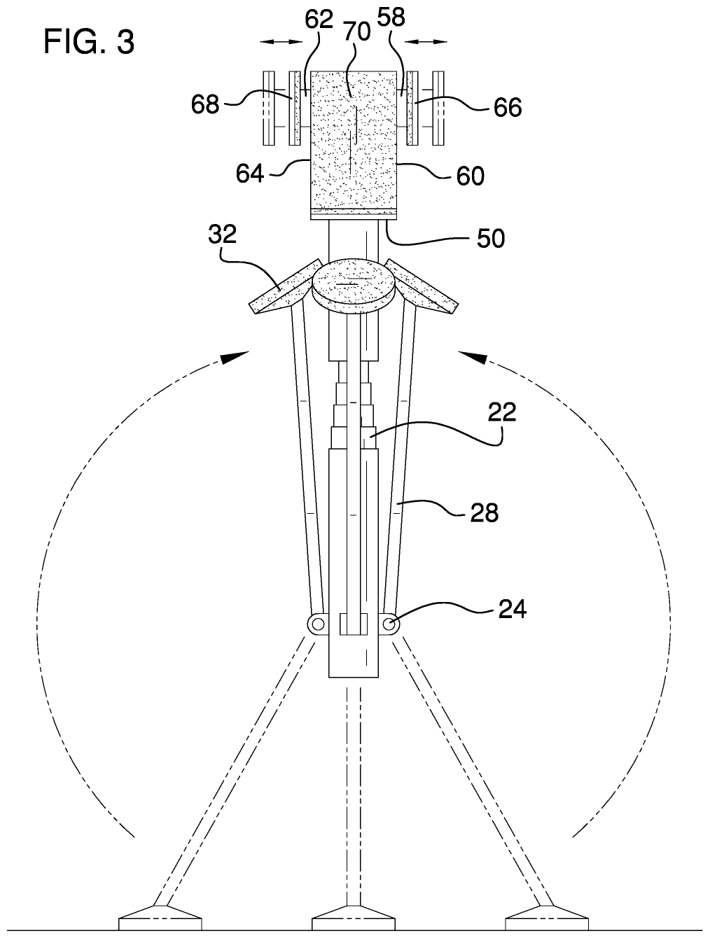

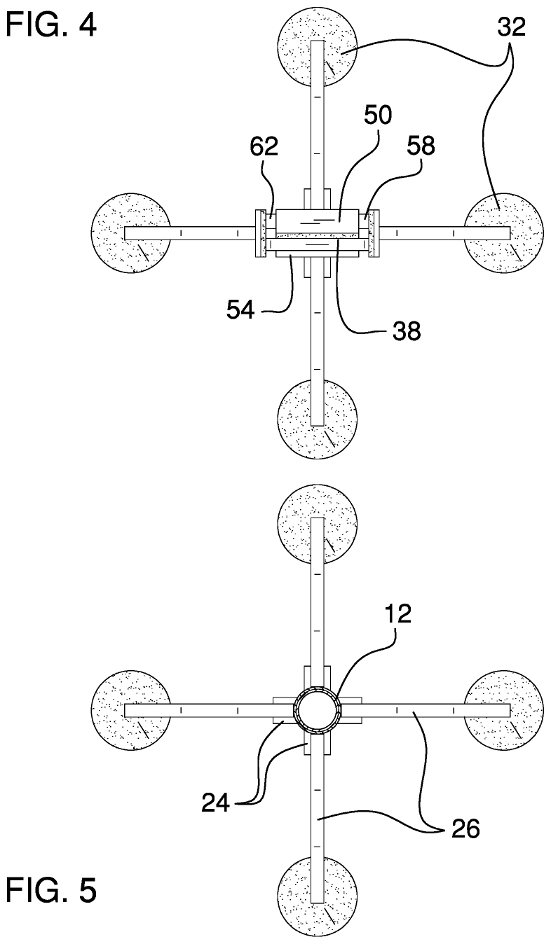

With reference now to the drawings, and in particular to FIGS. 1 through 5 thereof, a new tripod embodying the principles and concepts of an embodiment of the disclosure and generally designated by the reference numeral 10 will be described.

As best illustrated in FIGS. 1 through 5, the collapsible mobile device stand 10 generally comprises a telescopic pole 12 having a top end 14, a bottom end 16, and a plurality of segments 18. Each of the plurality of segments is telescopably coupled within an adjacent segment of the plurality of segments. The telescopic pole has an extended position 20 and an alternate compacted position 22. A plurality of hinges 24 is coupled to the telescopic pole proximal the bottom end 16. A plurality of legs 26 is coupled to the plurality of hinges 24 such that each of the plurality of legs is independently foldable from a folded position 28 to an alternate extended position 30. Each of a plurality of feet 32 is coupled to a distal end 34 of one of the plurality of legs. Each of the plurality of feet 32 may be round and rubberized to provide better grip and to not scratch a floor surface. Each of the plurality of hinges 24, the plurality of legs 26, and the plurality of feet 32 may be four.

A device holder assembly 36 is coupled to the top end 14 of the telescopic pole to secure and alternatively release a mobile device 38. The device holder assembly may have a pole mount 40 coupled to the top end 14 of the telescopic pole with the pole mount having a mount diameter 42 greater than a pole diameter 44 of the telescopic pole 12. The pole mount thus remains exposed when the telescopic pole is in the compacted position 22. A device support 46 has a base 48 and a back 50. The base 48 is coupled to the pole mount 40 and the back is perpendicularly coupled to the base with the base extending beyond a thickness 52 of the back to form a lip 54 for the mobile device 38 to rest on. A clamp 56 has a right arm 58 slidingly coupled within a right side 60 of the back 50 of the device support and a left arm 62 slidingly coupled within a left side 64 of the back 50 of the device support. Each of the right arm 58 and the left arm 62 have a right clamp face 66 and a left clamp face 68, respectively. Each of the right clamp face 66 and the left clamp face 68 is perpendicular to each of the right arm 60 and the left arm 62, respectively. A rubberized padding 70 may be coupled to each of the lip 54 and the back 50 of the device support and to each of the right clamp face 66 and the left clamp face 68 to protect the mobile device 38 and to prevent the mobile device from slipping.

In use, a user extends the telescopic pole 12 from the compacted position 22 to the extended position 20 and unfolds each of the plurality of legs 26 from the folded position 28 to the extended position 30. He then places the mobile device 38, such as a cellphone, to rest on the lip 54 and the back 50 of the device support and slides the right arm 58 and the left arm 62 inwards until the right clamp face 66 and the left clamp face 68 securely grip the mobile device. The mobile device may then be used hands free to take pictures and videos or to video chat.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A collapsible mobile device stand comprising:
a telescopic pole having a top end, a bottom end, and a plurality of segments, each of the plurality of segments being telescopably coupled within an adjacent segment of the plurality of segments, the telescopic pole having an extended position and a compacted position;
a plurality of hinges coupled to the telescopic pole, the plurality of hinges being coupled proximal the bottom end;
a plurality of legs coupled to the plurality of hinges, each of the plurality of legs being independently foldable from a folded position to an extended position;
a plurality of feet coupled to the plurality of legs, each of the plurality of feet being coupled to a distal end of one of the plurality of legs; and
a device holder assembly coupled to the top end of the telescopic pole, the device holder being configured to secure and alternatively release a mobile device, the device holder comprising
a pole mount coupled to the top end of the telescopic pole, the pole mount being cylindrical and having a mount diameter greater than a pole diameter of the telescopic pole, the pole mount receiving the top end of the telescopic pole such that the telescopic pole and the pole mount share a common central longitudinal axis, the pole mount extending around the top end of the telescopic pole and remaining exposed when the telescopic pole is in the compacted position, said pole mount having a length wherein said pole mount is configured to be grasped by a user;
a device support coupled to the pole mount, the device support having a base and a back, the base being coupled to the pole mount, the back being perpendicularly coupled to the base, the base extending beyond a thickness of the back to form a lip; and
a clamp coupled to the device support, the clamp having a right arm and a left arm, the right arm being slidingly coupled within a right side of the back of the device support, the left arm being slidingly coupled within a left side of the back of the device support, each of the right arm and the left arm having a right clamp face and a left clamp face, respectively, each of the right clamp face and the left clamp face being perpendicular to each of the right arm and the left arm, respectively.

2. (canceled)

3. The collapsible mobile device stand of claim 1 further comprising a padding, the padding being coupled to each of the lip and the back of the device support and to each of the right clamp face and the left clamp face.

4. The collapsible mobile device stand of claim 1 further comprising each of the plurality of feet being round.

5. The collapsible mobile device stand of claim 1 further comprising each of the plurality of feet being rubberized.

6. The collapsible mobile device stand of claim 1 further comprising each of the plurality of hinges, the plurality of legs, and the plurality of feet being four.

7. A collapsible mobile device stand comprising:
a telescopic pole having a top end, a bottom end, and a plurality of segments, each of the plurality of segments being telescopably coupled within an adjacent segment of the plurality of segments, the telescopic pole having an extended position and an alternate compacted position;
a plurality of hinges coupled to the telescopic pole, the plurality of hinges being coupled proximal the bottom end;
a plurality of legs coupled to the plurality of hinges, each of the plurality of legs being independently foldable from a folded position to an alternate extended position;
a plurality of feet coupled to the plurality of legs, each of the plurality of feet being coupled to a distal end of one of the plurality of legs, each of the plurality of feet being round and rubberized;
wherein each of the plurality of hinges, the plurality of legs, and the plurality of feet is four;
a device holder assembly coupled to the top end of the telescopic pole, the device holder being configured to secure and alternatively release a mobile device, the device holder assembly comprising:
a pole mount coupled to the top end of the telescopic pole, the pole mount being cylindrical and having a mount diameter greater than a pole diameter of the telescopic pole, the pole mount receiving the top end of the telescopic pole such that the telescopic pole and the pole mount share a common central longitudinal axis, the pole mount extending around the top end of the telescopic pole and remaining exposed when the telescopic pole is in the compacted position, said pole mount having a length wherein said pole mount is configured to be grasped by a user;
a device support coupled to the pole mount, the device support having a base and a back, the base being coupled to the pole mount, the back being perpendicularly coupled to the base, the base extending beyond a thickness of the back to form a lip;
a clamp coupled to the device support, the clamp having a right arm and a left arm, the right arm being slidingly coupled within a right side of the back of the device support, the left arm being slidingly coupled within a left side of the back of the device support, each of the right arm and the left arm having a right clamp face and a left clamp face, respectively, each of the right clamp face and the left clamp face being perpendicular to each of the right arm and the left arm, respectively; and
a padding, the padding being coupled to each of the lip and the back of the device support and to each of the right clamp face and the left clamp face.
